(19) United States
(12) Patent Application Publication
(10) Pub. No.: US 2019/0090154 A1
(43) Pub. Date: Mar. 21, 2019

(54) DISCOVERY, LOCATION DETERMINATION, AND CROSSCHECKING OF NETWORK-CONNECTED DATA CENTER COMPONENTS

(71) Applicant: Nutanix, Inc., San Jose, CA (US)

(72) Inventors: Jan Olderdissen, Herrenberg (DE); Nick Neely, San Jose, CA (US)

(73) Assignee: Nutanix, Inc., San Jose, CA (US)

(21) Appl. No.: 15/711,140

(22) Filed: Sep. 21, 2017

(51) Int. Cl. H04W 28/02; H04W 64/00; H04W 80/04

(52) U.S. Cl. CPC H04W 28/0273; H04W 80/04; H04W 64/003

(57) ABSTRACT

A method for configuring components in a data center is disclosed. The method includes receiving, by a management server, a request for an internet protocol (IP) address and media access control (MAC) address from a network-connected component, responsive to receiving the request, issuing, by the management server, an IP address to the network-connected component, associating, by the management server, the issued IP address with the received MAC address, providing, by the management server, a query to the network-connected component for identifying information associated with the network-connected component, receiving, by the management server, the identifying information, and configuring, by the management server, the network-connected component based on the identifying information.

### BACKGROUND

Bringing a datacenter online has typically been a manually intensive process susceptible to difficult to detect, but highly impactful errors. Typically, bringing a datacenter online involves manually installing and connecting (referred to as “cabling”) hardware components (e.g., switches, routers, servers, etc.) to one another. The installation and cabling is performed by technicians and/or contractors that use a predefined map to install different component types at particular positions within a server rack and connect the components according to a cable map. The components are typically then configured through software installation and testing that can expose errors that occurred in the installation process. For example, configuration and testing can expose errors in missing or incorrect hardware, hardware defects (such as broken components), incorrect hardware installation, incorrect cabling between components, and components that have been manually configured incorrectly. The locations of and solutions to these errors are often difficult to determine as a datacenter may include hundreds or thousands of components and tens of thousands of individual connections between components.

### SUMMARY

According to one embodiment, a method for configuring components in a data center is disclosed. The method includes receiving, by a management server, a request for an internet protocol (IP) address and media access control (MAC) address from a network-connected component, responsive to receiving the request, issuing, by the management server, an IP address to the network-connected component, associating, by the management server, the issued IP address with the received MAC address, providing, by the management server, a query to the network-connected component for identifying information associated with the network-connected component, receiving, by the management server, the identifying information, and configuring, by the management server, the network-connected component based on the identifying information.

According to another embodiment, a method of determining a physical location of network-connected computing nodes in a data center is disclosed. The method includes identifying, by a management server, a rack housing a plurality of network switches and a plurality of computing nodes coupled to the plurality of network switches, identifying, by the management server, a network switch of the plurality of network switches, accessing, by the management server, an address resolution protocol (ARP) table to determine an actual cable connection between the identified switch and a computing node of the plurality of computing nodes, accessing, by the management server, a cable map to determine a predicted connection information between the plurality of switches and the plurality of computing nodes, and determining, by the management server, a physical location of each computing node of the plurality of computing nodes based on the ARP table and the cable map.

According to yet another embodiment, a method of cross checking cabling between network-connected components is disclosed. The method includes selecting, by a processor, a first port of a computing node to cross check, determining, by the processor, an expected connection between the first port of the computing node and a first port of a network switch, determining, by the processor, an actual connection of the first port of the network switch, determining, by the processor, whether the actual connection of the first port of the network switch matches the expected connection between the first port of the computing node and the first port of the network switch, and responsive to determining that the actual connection does not match the expected connection, transmitting, by the processor, an alert.

### BRIEF DESCRIPTION OF THE DRAWINGS

FIG. 1 is a block diagram of a spine and leaf infrastructure with a management server, in accordance with an embodiment of the present invention.

FIG. 2 is a block diagram of a spine rack and a leaf rack, in accordance with an embodiment of the present invention.

FIG. 3 is a flowchart illustrating a method of discovering datacenter components, in accordance with an embodiment of the present invention.

FIG. 4 is a flowchart illustrating a method of determining physical locations of datacenter components, in accordance with an embodiment of the present invention.

FIG. 5 is a flowchart illustrating a method of cross checking cabling of components in a data center, in accordance with an embodiment of the present invention.

FIG. 6 is a block diagram of a spine and leaf infrastructure with a serial concentrator, in accordance with an embodiment of the present invention.

FIG. 7 is a flowchart illustrating a method of performing location determination and cross checking component connections for power distribution units, in accordance with an embodiment of the present invention.

FIG. 8 is a flowchart depicting a method of cross checking cable connections between data center components, in accordance with an embodiment of the present invention.

### DETAILED DESCRIPTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

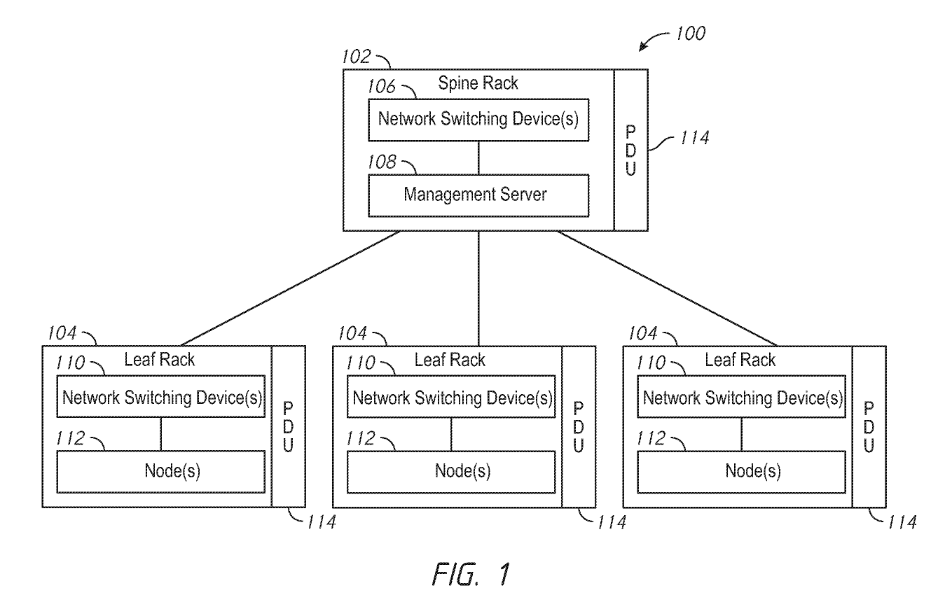

FIG. 1 is a block diagram of a spine and leaf datacenter architecture, generally designated 100, in accordance with an embodiment of the present invention. The spine and leaf architecture 100 includes one or more spine racks 102 (also called infrastructure racks) coupled to a plurality of leaf racks 104 (also called production racks). The spine rack 102 may house or be coupled to a number of hardware components, such as servers, network switching devices (e.g. network switches, routers, hubs, etc.), and power distribution units (PDUs). In the embodiment of FIG. 1, the spine rack houses one or more network switching devices 106, and a management server 108 and is coupled to a PDU 114. In various embodiments, each of the network switching devices 106, the management server 108, and the PDU 114 may be dynamic host configuration protocol (DHCP) enabled devices. The network switching devices 106 may be multiport network switches that use hardware addresses to process and forward data between the spine rack 102 and one or more of the leaf racks 104. The network switching devices 106 may be, for example, network switches, network bridges, media access control (MAC) bridges, or any other type of computer networking device. In various embodiments, the network switching devices 106 may communicate over one or more of Ethernet, Fibre Channel, Asynchronous Transfer Mode, and/or Infiniband.

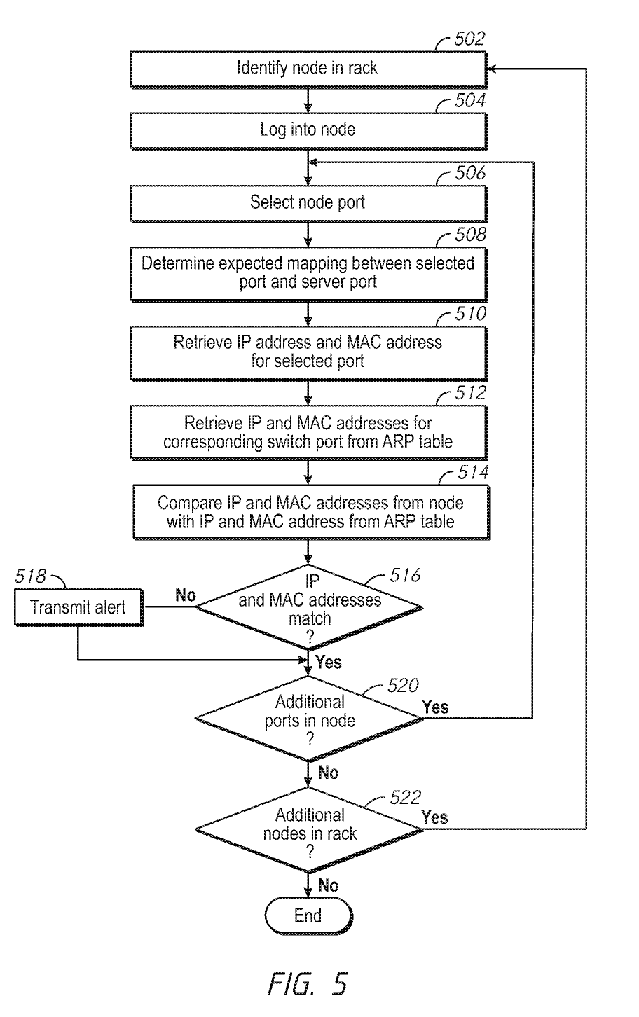

The management server 108 is a computing device that discovers, locates, tests, configures, and/or confirms the connections of the components housed in or coupled to the spine rack 102 and leaf racks 104. The management server 108 may include one or more processors and be coupled to one or more memory devices, such as a volatile and/or a non-volatile memory. The processor in the management server 108 may perform various operations according to this disclosure that enable the management server to discover, locate, test, configure, and/or confirm the connections between the various components included in the spine and leaf architecture in an automated way in order to reduce the burden in manually bringing up components in the datacenter and troubleshooting errors. Example components of a management server are discussed in further detail with respect to FIG. 5.

Each leaf rack 104 of the plurality of leaf racks may be coupled to the spine rack 102. The leaf racks 104 may house or be coupled to one or more network switching devices 110, one or more computing nodes 112, and a PDU 114. In other embodiments, the leaf racks 104 may house or be coupled to different or additional components, such as routers, etc. The network switching devices 110 connect the components in the leaf racks 104 to the components in the spine rack 102 via cabled connections. The network switching devices 110 may be implemented as similar types of devices as the network switching devices 106 of the spine rack 102. The computing nodes 112 may include one or more processors and be coupled to one or more memory devices, such as a volatile and/or non-volatile memory.

Each of the spine rack 102 and the leaf racks 104 may be coupled to a power distribution unit (PDU) 114 that provides power to the respective rack. In some embodiments, the PDUs 114 may be network-connected PDUs that are coupled to the management server over a network (for example, through the network switching devices 106 and 110). In such embodiments, the power operations performed by the PDUs 114 (e.g., power on, power off, etc.) may be monitored and controlled remotely.

As shown in FIG. 1, the management server 108 may be coupled to the one or more of the network switching devices 106 of the spine rack 102. The network switching devices 106 of the spine rack 102 may be coupled to one or more of the network switching devices 110 of the leaf racks 104 via cable connections. The one or more network switching devices 110 of the leaf racks 104 may be coupled to the nodes 112 and the PDUs 114 in each of the leaf racks 104. Thus, the management server 108 is physically linked with each of the components housed in or coupled to the spine rack 102 and the leaf racks 104. Via the physical link, the management server can discover, locate, test, configure, and/or confirm the connections between the various components included in the spine and leaf architecture.

While a particular architecture is shown in Figures described herein, such as FIG. 1, it is to be understood that generally any topology of interconnected nodes and switches may be discovered and managed using techniques described herein. The techniques may generally be applied recursively to any depth. For example, while a single spine rack 102 is shown connected to multiple leaf racks 104 in FIG. 1, in some examples, the spine rack 102 may itself include components of one or more leaf racks 104. For example, the spine rack 102 may include one or more network switching device(s) 110 and node(s) 112. Generally, there may be a difference between a conceptual layout and a physical layout of the racks. Conceptually, there may be 2 to 32 production racks in some examples, one management rack and one network rack in some examples. However, as the network and management racks may have sufficient space, they may be combined into a single rack in some examples. Moreover, while nodes and switches are described herein, the techniques described may be used with other equipment additionally or instead in some examples such as, but not limited to, routers, power distribution units (PDUs), and/or firewalls.

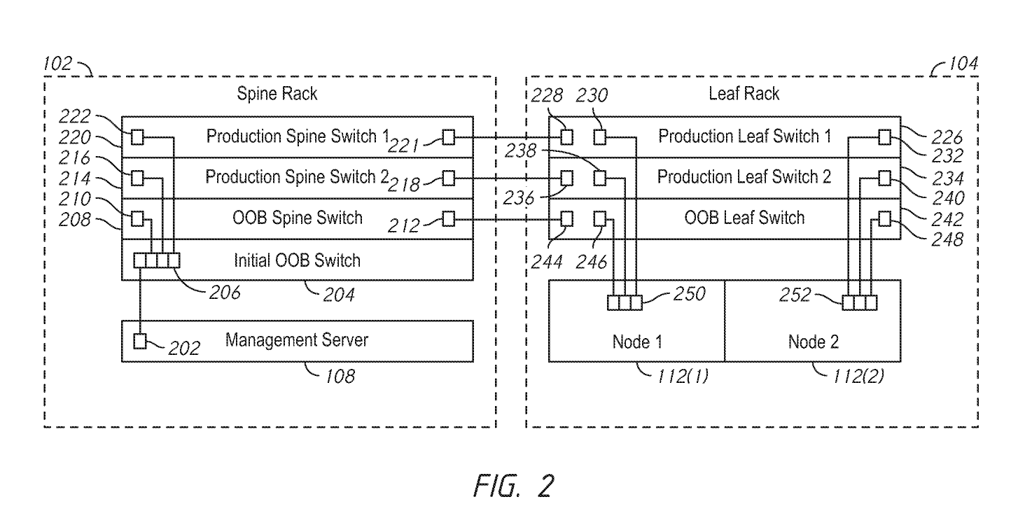

FIG. 2 is a block diagram of a spine rack 102 and a leaf rack 104, in accordance with an embodiment of the present invention. The embodiment of FIG. 2 illustrates example connections between components housed in the spine rack 102 and the leaf rack 104. Each of the connections described below may be predictably determined using a cable mapping algorithm and may be recorded in a cable mapping data store that stores the predicted connections between components.

The spine rack 102 houses a management server 108, an initial out-of-band (OOB) switch 204, an OOB spine switch 208, a first production spine switch 220, and a second production spine switch 214. The management server 108 may be implemented as described above with respect to FIG. 1. In the embodiment of FIG. 2, the management server 108 includes a port 202 for connecting to other components. In some examples, the management server 108 may be further connected to leaf switches which may be present in the spine rack 102. The initial out-of-band (OOB) switch 204, the OOB spine switch 208, the first production spine switch 220, and the second production spine switch 214 may each be network switching devices, such as those described with respect to FIG. 1 as network switching devices 106. For example, the initial out-of-band (OOB) switch 204, the OOB spine switch 208, the first production spine switch 220, and the second production spine switch 214 may each be implemented as network switches. The initial OOB spine switch 204 includes ports 206 and provides an initial link between the management server 108 and the OOB spine switch 208, the first production spine switch 220, and the second production spine switch 214. The OOB spine switch 208 is a network switch that provides a channel, which may be a dedicated channel, for managing components in the data center, such as the nodes 112. The OOB spine switch includes a first port 210 that is connected to one of the ports 206 of the initial OOB switch 204. The OOB spine switch further includes a second port 212.

The first production spine switch 220 and the second production spine switch 214 are redundant in-band switches that provide links to components in the leaf rack 104. The first production spine switch 220 includes a first port 222 that is connected to one of the ports 206 of the initial OOB switch 204. The first production spine switch 220 further includes a second port 224. The second production spine switch 214 includes a first port 216 that is connected to one of the ports 206 of the initial OOB switch 204. The second production spine switch 214 further includes a second port 218.

The leaf rack 104 houses a first production leaf switch 226, a second production leaf switch 234, an OOB leaf switch 242 and two nodes 112(1) and 112(2). The first production leaf rack 226, the second production leaf switch 234, and the OOB leaf switch 242 may each be implemented as described above with respect to network switching devices 110. For example, each of the first production leaf switch 226, the second production leaf switch 234, and the OOB leaf switch 242 may be a network switch. The first production leaf switch 226 may include ports 228, 230, and 232. The second production leaf switch 234 may include ports 236, 238, and 240. The OOB leaf switch 242 may include ports 244, 246, and 248. Each of the first production leaf rack 226, the second production leaf switch 234, and the OOB leaf switch 242 may generally include any number of ports. The nodes 112(1), 112(2) may be implemented as described above with respect to nodes 112 in FIG. 1 and include ports 250 and 252, respectively. Although only two nodes 112 are shown, those skilled in the art will appreciate that any number of nodes may be housed in the leaf rack 104. Each of the nodes 112(1), 112(2) may have an IP address and a MAC address for each of their respective ports. For example, the first node 112(1) may be assigned a respective IP address (e.g., through discovery and imaging processes described herein) and may have a MAC address for each of the ports 250 and the second node 112(2) may be assigned a respective IP address and may have MAC address for each of the ports 252. MAC addresses may be hard-coded in some examples in persistent memory, which may be write-only in some examples. In some examples, MAC addresses may be fused during chip production. IP addresses may be assigned (e.g., using DHCP) and may be stored in some examples in a memory (e.g., EEPROM) or on disk (e.g., for operating systems).

The first production leaf switch 226, the second production leaf switch 234, and the OOB leaf switch 242 may provide connections between the first production spine switch 220, the second production spine switch 214, and the OOB spine switch 208, respectively, and the nodes 112(1), 112(2). The first production leaf switch 226 may include a first port 228 that is coupled to the port 224 of the first production spine switch 220, a second port 230 that is coupled to a port 250 of the first node 112(1) and a third port 232 that is coupled to a port 252 of the second node 112(2). The second production leaf switch 234 may include a first port 236 that is coupled to the port 218 of the second production spine switch 214, a second port 238 that is coupled to a port 250 of the first node 112(1) and a third port 240 that is coupled to a port 252 of the second node 112(2). The OOB leaf switch 242 may include a first port 244 that is coupled to the port 212 of the OOB spine switch 208, a second port 246 that is coupled to a port 250 of the first node 112(1) and a third port 248 that is coupled to a port 252 of the second node 112(2). Each of the switches described above may include an address resolution protocol (ARP) table that describes the mapping between each switch port and the MAC address and IP address of the component connected to that port.

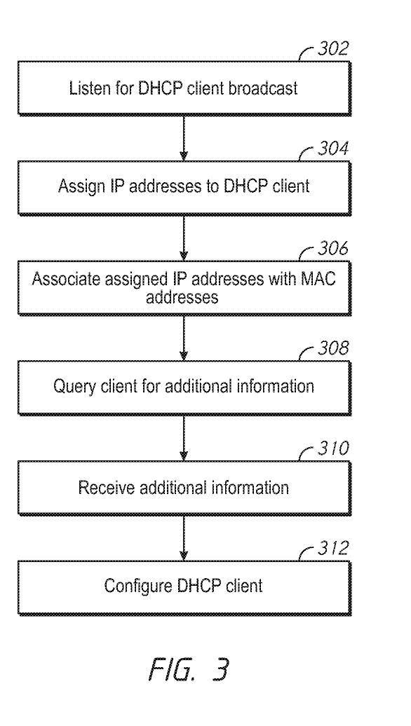

FIG. 3 is a flowchart illustrating a method of discovering datacenter components, in accordance with an embodiment of the present invention. In operation 302, the management server 108 listens for a DHCP client broadcasting its presence. For example, the initial out-of-band (OOB) switch 204, the OOB spine switch 208, the first production spine switch 220, the second production spine switch 214, the first production leaf switch 226, the second production leaf switch 234, the OOB leaf switch 242, and/or the nodes 112(1), 112(2) may broadcast their presence to the management server 108 using the DHCP protocol, or other protocol, by transmitting a signal to a destination address. The destination address may be a default destination address or may be a predefined address of the management server 108. The signal may include the MAC address for the client device and a request that an internet protocol (IP) address be assigned to the DHCP client. In response to receiving the DHCP client broadcast, the management server 108 detects the DHCP client broadcast and determines the MAC address associated with the broadcasting device.

In operation 304, the management server 108 assigns an IP address to a broadcasting DHCP client. For example, the management server may issue a message to the DHCP client containing the client's MAC address, the IP address that the management server 108 is offering, the duration of the IP address lease, and the IP address of the management server 108. In operation 306, the management server 108 may associate assigned IP addresses with the corresponding MAC addresses in a table.

Once an IP address has been assigned to the DHCP client(s), the DHCP clients may be queried for additional information in operation 308 via DHCP, IPMI, ssh, or other protocols. While querying is shown in FIG. 3, there are a variety of ways in which a network attached component could be configured in various embodiments. Information to identify the component can be sent in the initial DHCP request (e.g., operation 302) in some examples, information may be queried (e.g., as shown in operation 308) in some examples, and/or the device may request its configuration information autonomously from the DHCP server or some other server, based on its identifying information, for example its serial number or its MAC address in some examples. The management server 108 may receive the requested additional information in operation 310. Such additional information may be used to image and/or configure the DHCP client in operation 312. For example, the management server may provide a boot image to one or more of the nodes 112. Configurations may be communicated to the various components, for example, using Zero Touch Provisioning (ZTP) or Preboot Execution Environment (PXE) protocols.

In various embodiments, the operations of FIG. 3 may be performed iteratively to discover devices coupled to the management server. For example, with reference to FIG. 2, the management server 108 may first listen for and detect a DHCP broadcast from the initial OOB switch 204. In response, the management server 108 may issue an IP address to the initial OOB switch 204, query the initial OOB switch 204 for additional information, and configure the initial OOB switch. Once the initial OOB switch 204 is configured, the management server may listen for other DHCP client devices that are coupled to the management server 108 through the initial OOB switch 204. For example, the OOB spine switch 208, the first production spine switch 220, and the second production spine switch 214 may broadcast their DHCP requests to the management server 108 through the ports 206 of the initial OOB server 204. In response to the received DHCP broadcasts, the management server 108 may provide IP addresses to the requesting devices, query the newly discovered devices for additional information, and configure the newly discovered devices. Once the OOB spine switch 208, the first production spine switch 220, and the second production spine switch 214 have been configured, the management server 108 may discover DHCP clients that are coupled to the management server 108 through the initial OOB switch 204, the OOB spine switch 208, the first production spine switch 220, and/or the second production spine switch 214. For example, the management server 108 may detect DHCP broadcasts from the first production leaf switch 226, the second production leaf switch 234, and/or the OOB leaf switch 242 through the first production spine switch 220, the second production spine switch 214, and the OOB spine switch 208, respectively. Similarly, the nodes 112(1), 112(2) may be discovered, assigned an IP address, queried, configured, and/or imaged. Similar methods to those presented above may also be used to discover and configure new components added to a data center after the initial bring up of the datacenter, such as when new nodes 112 are introduced to the data center.

In some examples, the serving of DHCP IP addresses after an initial switch configuration may be provided by the switches themselves. For example, switches may provide DHCP functionality as a configurable option. In this manner, a management server may receive assigned DHCP addresses and associated MAC addresses from the switch.

In some examples, a DHCP relay may be enabled on a switch (e.g., using one or more commands) in the same network as device(s) being discovered (e.g., servers, switches). DHCP requests coming from the devices may be related over IP to the management server. A DHCP relay may be installed in each subnet (e.g., each leaf rack). In this manner, device discovery may take place in multiple subnets (e.g., leaf racks) in parallel, without requiring the management server to be in any of the networks.

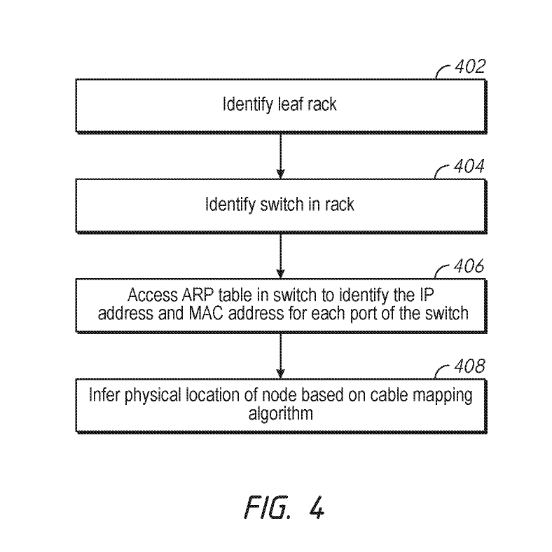

Once one or more of the components have been discovered, it may be useful to determine the physical locations of the various components within the data center and/or to confirm that the cabling, as completed by the technicians/contractors, is correct and in accordance with the cabling map. Location determination may be useful for various data center management operations, such as distributing redundant data across geographically separated devices (both within a single data center and across multiple data centers). Moreover, if a component breaks or encounters an error, manual replacement may be necessary and knowing the physical location of the component within the data center may substantially accelerate replacement because data center operators do not need to search for the device. FIG. 4 is a flowchart illustrating a method of determining physical locations of and verifying connections between datacenter components, in accordance with an embodiment of the present invention.

In operation 402, the management server 108 identifies a leaf rack 104. A data center may include any number of leaf racks 104. The management server 108 may iteratively determine the locations of the components in the data center on a rack by rack basis. For example, the leaf racks 104 may be numbered, and the management server 108 may proceed through the leaf racks 108 in numerical order. In another example, the management server 108 may proceed through the leaf racks 104 in a different type of order. Generally, any method of identifying a leaf rack 104 may be used.

In operation 404, the management server 108 identifies a switch in the identified leaf rack 104. For example, the management server 108 may identify one of the first production leaf switch 226, the second production leaf switch 234, or the OOB leaf switch 242. In one embodiment, each slot in a leaf rack may be assigned a number from top to bottom or vice versa, and the management server 108 may identify a switch at the top or the bottom position in the leaf rack 104 and proceed down or up the leaf rack 104, respectively. For example, with reference to FIG. 2, the first production leaf switch 226 may be in slot 1 of the leaf rack 104, the second production leaf switch 234 may be in slot 2 of the leaf rack 104, and the OOB leaf switch 242 may be in slot 3 of the leaf rack 104. In a first iteration of the method of FIG. 4, the management server 108 may identify the first production leaf switch 226 in operation 404.

In operation 406, the management server 108 accesses the ARP table in the identified switch to determine the cabling of the identified switch. The ARP table generally includes the IP address of each port of each server connected to the switch, the MAC address of each port of each server that is connected to the switch and the port number of each switch port corresponding to the connected IP addresses and MAC address of the server ports. For example, with reference to FIG. 2, the first production leaf switch 226 has an ARP table that includes at least 2 entries (one for each of ports 230 and 232). For the entry for the port 232, the ARP table includes an IP address and a MAC address for the port 250 of the first node 112(1) that is coupled to the port 230. Similarly, the entry for the port 232 includes an IP address and a MAC address for the port 252 of the second node 112(2) that is coupled to the port 232. Thus, the ARP table provides the actual connections between switch ports and server ports, and by referencing the ARP table, the management server 108 may determine which ports of which node 112 are coupled to which ports of which switches in the leaf rack. However, merely knowing which ports are coupled together may not, in and of itself, provide the physical location of the components within the leaf rack 104.

In operation 408, the management server 108 infers the physical location of a node for each port of the identified switch. The management server 108 may store and/or access a representation of a cable map or the algorithm used in cable mapping. The representation and/or algorithm indicates which components should be connected to which other components. For example, the cable map may include predicted connection information between the plurality of network switches and the plurality of computing nodes. The cable map may be the same cable map (e.g., a copy and/or digital representation of a same cable map) that was used by the technicians when installing the components in the data center. The cable map may provide information as to the physical location of each component to which the ports of the identified switch are supposed to be connected. Based on the actual switch port to component addresses determined in operation 406 and the location of the component in the rack as shown in the cable map, the physical location in the rack of each component may be inferred. For example, with respect to FIG. 2, the management server 108 determined in operation 406 that the port 230 of the first production leaf switch 226 is coupled to a port 250 of the first node 112(1) based on the ARP table stored in the first production leaf switch 226. Additionally, the cable map may provide information indicating that the port 230 of the first leaf production switch 226 should be coupled to a specific port (e.g., a first port) of a node in the fourth slot from the top of the leaf rack 104. Therefore, based on the above information, the management server 108 may infer that the port associated with the IP and MAC addresses that are coupled to the port 230 is part of the first node 112(1), which is located in the fourth slot of the leaf rack 104. Using this information, if, for example, the component at the IP and MAC addresses coupled to the port 230 becomes nonresponsive, or errors occur, a data center manager may know exactly which leaf rack 104 and which slot in the leaf rack 104 to go to in order to repair or replace the malfunctioning component. Additionally, the management server can use the determined physical locations to distribute redundant data across physically distant components to aid in preserving data integrity in the event of a disaster, such as a flood or fire within the data center. Such redundancy may be helpful in the event that occurs within a datacenter (e.g., a flood or fire in a portion of the datacenter). The management server may store the inferred location of components.

In addition to determining the physical locations of the components within the data center, it may also be useful to cross check the cabling between components to identify errors in cabling that may have occurred when the components were first installed by the technicians. FIG. 5 is a flowchart depicting a method of cross checking cable connections between data center components, in accordance with an embodiment of the present invention. In operation 502, the management server 108 identifies a node in a leaf rack 104. The management server may iteratively proceed through the leaf rack, for example from top to bottom, from bottom to top, or in any other order. In operation 504, the management server 108 may log into the identified node. For example, the management server 108 may identify and log into the first node 112(1) in operation 502 and 504. The management server 108 may log into the node, for example, by providing credentials to the node that verify that the management server 108 is authorized to communicate with the node.

In operation 506, the management server 108 selects a port of the identified node 112. In some embodiments, each port may be assigned a number, and the management server 108 may iteratively select a port based on the numerical assignment. For example, the management server 108 may select the port with the lowest numerical assignment that has not previously been analyzed using the operations of the method of FIG. 5.

In operation 508, the management server 108 determines the expected connection between the selected node port and a server port. The management server 108 may determine the expected connection by referring to the cable map or the cable mapping algorithm for the leaf rack 104 that is being cross checked. Specifically, the management server 108 may search the cable map for the selected node port and identify the particular switch port to which the selected node port should be connected according to the cable map.

In operation 510, the management server 108 retrieves the IP and MAC addresses for the selected port from the selected node 112. Each node 112 may store the IP and MAC address for each port of that node 112. Once the management server 108 is logged into the node 112, the management server 108 may query the node 112 to retrieve the recorded IP and MAC addresses of the selected port. In response to the query, the node 112 may provide the requested IP and MAC addresses to the management server 108.

In operation 512, the management server 108 retrieves the IP and MAC addresses for the switch port coupled to the selected node port based on the cable map. For example, the management server 108 may determine that the first port of the selected node is being checked. According to the cable map, the management server 108 may determine that the selected node port should be coupled to the port 230 of first production leaf switch 226. The management server 108 may then query the first production leaf server 226 to retrieve the ARP table and compare the IP and MAC addresses that the switch port is actually connected to (as reflected in the ARP table) with the IP and MAC addresses of the expected port (as determined in operation 510). In some examples, ARP tables may have a timeout for each entry, so entries may disappear in the absence of traffic to and from the target device. In some examples, the target IP address may be pinged prior to querying the ARP table for a given IP address to aid in ensuring the ARP table may contain the desired data.

In decision block 516, the management server 108 determines whether the IP and MAC addresses in the ARP table match the IP and MAC addresses retrieved from the node 112. If the IP and MAC address do not match (decision block 516, NO branch), then the result may be indicative of an error in the cabling between the selected node port and the corresponding switch port and the management server 108 may transmit an alert to a data center technician in operation 518. The alert may generally be in any form, such as an email, a text message, a pop-up screen, or any other suitable form of communication. The alert may include, for example, identifying information about the selected node and/or the server, such as the port number, the serial number (as determined by querying the components for additional information during the discovery phase as discussed above with respect to FIG. 3), the location of the node (as determined above with respect to FIG. 4), or any other suitable identifying information.

If the IP and MAC addresses match (decision block 516, YES branch), then the management server 108 determines whether there are additional ports in the identified node in decision block 520. As discussed above, each port in the selected node 112 may be numbered and the management server may proceed iteratively through each port of the node 112. In such embodiments, the management server 108 may determine whether there are additional ports in the node 112 by determining whether there is another port of the node 112 with a numerical value greater than the port of the most recently analyzed port. If the management server 108 determines that the node 112 includes additional ports (decision block 520, YES branch, then the management server 108 selects a new port in the identified node 112 in operation 506. If the management server 108 determines that there are no additional ports in the identified node (decision block 520, NO branch), then the management server 108 determined whether there are additional nodes 112 in the leaf rack 104 in decision block 522. As discussed above, the nodes 112 may be stacked in the leaf rack 104 and the management server may proceed from the top node 112 to the bottom node 112, or vice versa until all ports of all nodes 112 have been cross checked. If the management server 108 determines that there are no more nodes 112 in the leaf rack 104 that require cross checking (decision block 522, NO branch), then the method of FIG. 5 may terminate for the leaf rack 104 being cross checked. The method of FIG. 5 may be repeated for each leaf rack 104 in the data center.

While examples described herein have been described with reference to locating components based on a provided cable mapping or predictable cable mapping algorithm, in some examples, techniques described herein may be used to determine the cable mapping provided input regarding the physical server ports and DHCP discovery information.

For example, data retrieved through DHCP discovery may be cross-checked to associate a set of server ports to gather and correlate those with switch ports to which they are connected. In this manner, a cable map and/or cable mapping algorithm may not be initially known in some examples. For example, consider a situation where an installer lacked cabling discipline. Each rack may have a bundle of cables heading into it, but the cables may not be mapped in a systematic way and may lack labels. A user may want to discover what cables are connected where. DHCP discovery may be performed and then cross checked to associate a set of server ports together and to correlate those with the various switch ports to which they're connected. If the user provides location information (e.g. server with serial number A is in rack position X, server with serial number B is in rack position Y), an output may be produced that ties each switch port to a specific server port, which has a specific location within a specific rack, thereby allowing a technician to find and service it. This technique may also be performed recursively. For example, in a two-level hierarchy, the technique could be used to determine the cabling between the spine switch and leaf switches, and then between the leaf switches and the servers.

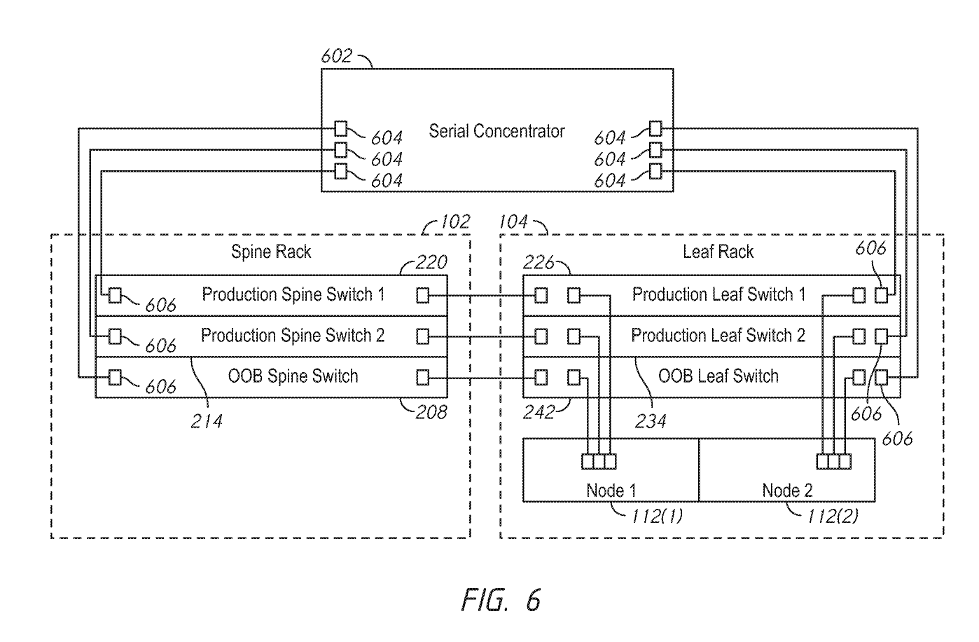

FIG. 6 is a block diagram of a spine and leaf infrastructure with a serial concentrator, in accordance with an embodiment of the present invention. In the embodiment of FIG. 6, a serial concentrator 602 replaces the management server 108 (as shown in FIGS. 1 and 2) to perform one or more of the discovery, location determination, configuring, or cross checking operations described above with respect to FIGS. 3-5. In other embodiments, the serial concentrator 602 may be provided in addition to the management server 108 to provide additional discovery, location determination, and cross checking capabilities. The serial concentrator 602 may generally be any type of electronic device capable of establishing a serial data connection with one or more data center components (e.g., the components of the spine rack 102 and/or the leaf rack 104) and communicating with those components over the serial data connection. The serial concentrator 602 multiplexes and provides access to the individual components' serial consoles over an IP network. The serial concentrator 602 includes a plurality of serial ports 604. The serial ports 604 may be coupled directly to a management port 606 in each of the components in the data center. For example, as shown in FIG. 6, a first serial port 604 is coupled directly to the management port 606 of the first production spine switch 220. A second serial port 604 is coupled directly to the management port 606 of the second production spine switch 220, and so on.

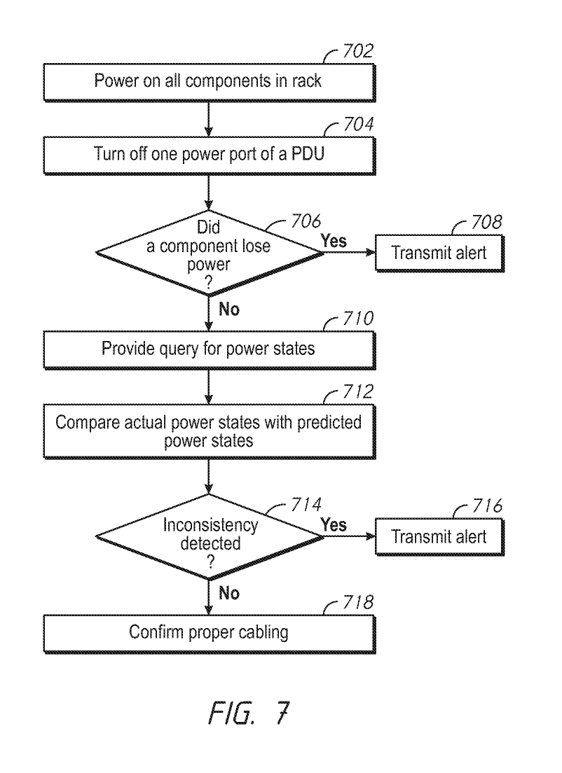

FIG. 7 is a flowchart illustrating a method of performing location determination and cross checking component connections for power distribution units, in accordance with an embodiment of the present invention.

PDUs 114 provide power to components such as servers and network switches. Smart, network-connected PDUs allow for remote monitoring and management of the PDU 114, including port-level monitoring and power operations (power off, power on).

Although not required, the addition of smart PDUs 114 enables repetition of the location determination, cross-checking, and testing techniques through an independent path, thereby providing flexibility and further independent verification in some examples.

In some embodiments, the nodes 112 may have redundant power supplies, with each connected to a different PDU 114. In a typical configuration, a single chassis has two power supplies, the first connected to a PDU 114 mounted on one side of the rack and the second connected to a PDU 114 mounted on the other side of the rack. All of the nodes 112 in a multi-node configuration can draw power from any of the power supplies in the rack. This arrangement is resilient to the failure of any single PDU 114 within a rack or any single power supply within a node 112.

As with network switches, the power cords between the PDUs 114 and node power supplies are connected in a predictable manner, such that a specific PDU 114 power port is connected to a specific power supply within a specific node 112. As with network connections, this information can be used for location determined, cross-checking, and testing.

In operation 702, all components in a rack are turned on. In one embodiment, the management server may provide an instruction to each of the components in the rack to power on. In another embodiment, the components in the rack may be manually powered on. In operation 704, a single power port is turned off at one of the PDUs 114. For example, the management server 108 may provide an instruction to a PDU 114 to deactivate one of its power ports. In decision block 706, the management server determines whether a component lost power. For example, the management server may transmit a request to the components coupled to the PDU to respond. If the component responds, then the component did not lose power. However, if the component fails to respond, then the component may have lost power. If the components have redundant power supplies and are properly cabled, none should turn off. The complete loss of power by any component with redundant power supplies may indicate a problem, either with the power supplies in that component or the connections to the PDUs, that needs to be investigated and rectified. If the management server 108 determines that a component lost power (decision block 706, YES branch), then the management server 108 provides an alert indicative of the power loss in operation 708.

If the management server 108 determines that no component has completely lost power (decision block 706, NO branch), then the management server provides a query to all components for the power states of their power supplies in operation 710. In operation 712, the management server 108 compares the actual power states, as determined in operation 710 with expected power states. Based on the power cable mapping, the management server 108 may predict which power supply should have lost power when an associated PDU 114 port was turned off. In operation 714, the management server 108 determines whether inconsistencies are detected between the actual power states as determined in operation 710 and the predicted power states as determined based on the cable map. Inconsistencies may include, but are not limited to more than one component indicating a power supply has lost power, an unexpected component indicating it has lost power, or an unexpected power supply within the expected component indicates it has lost power. If the management server 108 detects an inconsistency (decision block 714, YES branch), then the management server 108 provides an alert in operation 716 so that the inconsistency may be investigated and rectified. If the management server 108 does not detect any inconsistencies (decision block 714, NO branch), then the management server 108 confirms the proper cabling of the PDU 114 port to its associated power supply in operation 718. For example, a message or pop-up window may be displayed indicating that no errors were detected.

In an alternative embodiment, in which components do not have redundant power supplies, the loss of power may be confirmed by verifying that the expected component, and only the expected component, becomes unreachable when power is disabled and reachable again after power has been restored and an appropriate amount of time has elapsed to allow the component to boot. This entire technique may be repeated individually for each power port on all PDUs 114 powering a particular rack.

This technique may be implemented alternatively or additionally using a second method. Rather than powering off PDU power ports, individual components may be shut down via the appropriate action on that component (e.g., asking the operating system of a server to shut down). The power draw on the port(s) of the associated PDU(s) 114 may be monitored and used to determine if the expected power ports experienced reduced power demand at the time the component was shut down. This method may be less reliable than the methods discussed above, and may require that the components can be powered back on via some out-of-band method (e.g., IPMI, Wake on LAN, internal wake-up timers on a motherboard). However, it may be safer than the previously described methods, because it may guarantee which particular component is being powered off.

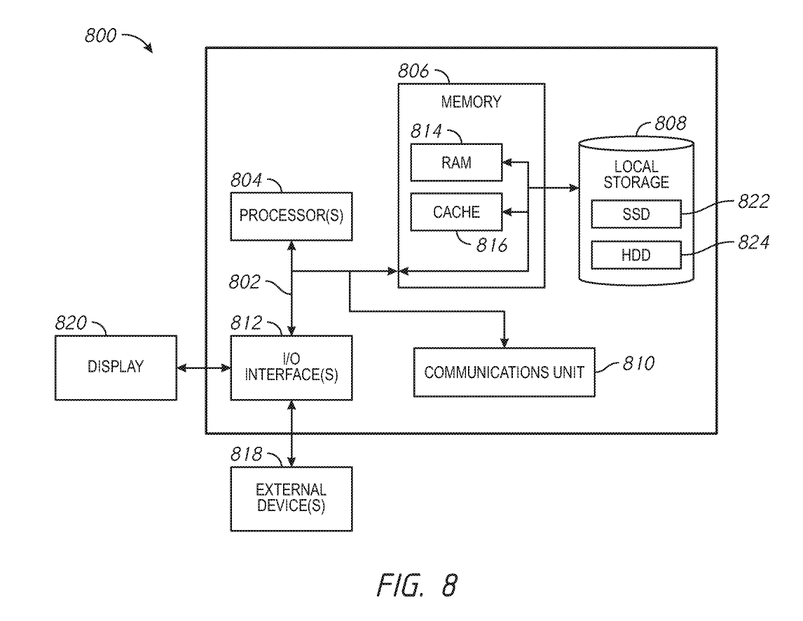

FIG. 8 depicts a block diagram of components of a computing node 800 in accordance with an embodiment of the present invention. It should be appreciated that FIG. 7 provides only an illustration of one implementation and does not imply any limitations with regard to the environments in which different embodiments may be implemented. Many modifications to the depicted environment may be made. The computing node 800 may implemented as the computing nodes 112.

The computing node 800 includes a communications fabric 802, which provides communications between one or more computer processors 804, a memory 806, a local storage 808, a communications unit 810, and an input/output (I/O) interface(s) 812. The communications fabric 802 can be implemented with any architecture designed for passing data and/or control information between processors (such as microprocessors, communications and network processors, etc.), system memory, peripheral devices, and any other hardware components within a system. For example, the communications fabric 802 can be implemented with one or more buses.

The memory 806 and the local storage 808 are computer-readable storage media. In this embodiment, the memory 806 includes random access memory (RAM) 814 and cache memory 816. In general, the memory 806 can include any suitable volatile or non-volatile computer-readable storage media. In this embodiment, the local storage 808 includes an SSD 822 and an HDD 824.

Various computer instructions, programs, files, images, etc. may be stored in local storage 808 for execution by one or more of the respective computer processors 804 via one or more memories of memory 806. In this embodiment, local storage 808 includes a magnetic hard disk drive 824. Alternatively, or in addition to a magnetic hard disk drive, local storage 808 can include the solid state hard drive 822, a semiconductor storage device, a read-only memory (ROM), an erasable programmable read-only memory (EPROM), a flash memory, or any other computer-readable storage media that is capable of storing program instructions or digital information.

The media used by local storage 808 may also be removable. For example, a removable hard drive may be used for local storage 808. Other examples include optical and magnetic disks, thumb drives, and smart cards that are inserted into a drive for transfer onto another computer-readable storage medium that is also part of local storage 808.

Communications unit 810, in these examples, provides for communications with other data processing systems or devices. In these examples, communications unit 810 includes one or more network interface cards. Communications unit 810 may provide communications through the use of either or both physical and wireless communications links.

I/O interface(s) 812 allows for input and output of data with other devices that may be connected to computing node 800. For example, I/O interface(s) 812 may provide a connection to external devices 818 such as a keyboard, a keypad, a touch screen, and/or some other suitable input device. External devices 818 can also include portable computer-readable storage media such as, for example, thumb drives, portable optical or magnetic disks, and memory cards. Software and data used to practice embodiments of the present invention can be stored on such portable computer-readable storage media and can be loaded onto local storage 808 via I/O interface(s) 812. I/O interface(s) 812 also connect to a display 820.

Display 820 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Those of ordinary skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Skilled artisans may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible, consistent with the principles and novel features as previously described.

What is claimed is:

1. A method for configuring components in a data center, the method comprising:
receiving, by a management server, a request for an internet protocol (IP) address and media access control (MAC) address from a network-connected component;
responsive to receiving the request, issuing, by the management server, an IP address to the network-connected component;
associating, by the management server, the IP address with the MAC address;
obtaining identifying information associated with the network-connected component;
receiving, by the management server, the identifying information;
iteratively repeating said receiving, issuing, associating, and providing for further network connected components connected to the management server through network connected components previously processed; and
configuring, by the management server, the network-connected components based on the identifying information.

2. The method of claim 1, wherein said obtaining identifying information comprises providing, by the management server, a query to the network-connected component for the identifying information.

3. The method of claim 1, wherein the network-connected component comprises a network switch and at least one of the further network connected components comprises a computing node.

4. The method of claim 1, wherein the network-connected component comprises a first network-connected component, and said iteratively repeating comprises:
receiving, by the management server, a second request for an internet protocol (IP) address and a second media access control (MAC) address from a second network-connected component, wherein the second network-connected component is connected to the management server through the first network-connected component;
responsive to receiving the second request, issuing, by the management server, a second IP address to the second network-connected component;
associating, by the management server, the second IP address with the second MAC address;
obtaining second identifying information associated with the second network-connected component;
receiving, by the management server, the second identifying information;
configuring, by the management server, the second network-connected component based on the second identifying information;
receiving, by the management server, a third request for an internet protocol (IP) address and a third media access control (MAC) address from a third network-connected component, wherein the third network-connected component is connected to the management server and the second network-connected component in parallel with the network-connected component;
responsive to receiving the third request, issuing, by the management server, a third IP address to the third network-connected component;
associating, by the management server, the third IP address with the third MAC address;
obtaining third identifying information associated with the third network-connected component;
receiving, by the management server, the third identifying information; and
configuring, by the management server, the third network-connected component based on the third identifying information.

5. The method of claim 4, wherein the network-connected component and the third network-connected component comprise redundant network switches coupling the management server with the second network-connected component.

6. The method of claim 1, wherein the identifying information comprises a serial number associated with the network-connected component.

7. The method of claim 1, wherein the request comprises a dynamic host configuration protocol (DHCP) request.

8. A method of determining a physical location of network-connected computing nodes in a data center, the method comprising:
identifying, by a management server, a rack housing a plurality of network switches and a plurality of computing nodes coupled to the plurality of network switches;
identifying, by the management server, a network switch of the plurality of network switches;
accessing, by the management server, an address resolution protocol (ARP) table to determine an actual cable connection between the switch and a computing node of the plurality of computing nodes;
accessing, by the management server, a cable map to determine a predicted connection information between the plurality of network switches and the plurality of computing nodes; and
determining, by the management server, a physical location of each computing node of the plurality of computing nodes based on the ARP table and the cable map.

9. The method of claim 8, wherein the ARP table comprises a plurality of entries including a port number for each port of the identified switch, an IP address of a computing node port coupled to each port of the identified switch, and a MAC address of the computing node port coupled to each port of the identified switch.

10. The method of claim 8, wherein the cable map comprises a predicted physical location of each computing node.

11. The method of claim 8 further comprising:
associating the IP and MAC addresses of ports of each computing node of the plurality of computing nodes with the physical location of each computing node.

12. The method of claim 8, wherein the predicted connection information comprises a slot number in the rack.

13. A method of cross checking cabling between network-connected components, the method comprising:
selecting, by a processor, a first port of a computing node to cross check;
determining, by the processor, an expected connection between the first port of the computing node and a first port of a network switch;
determining, by the processor, an actual connection of the first port of the network switch;
determining, by the processor, whether the actual connection of the first port of the network switch matches the expected connection between the first port of the computing node and the first port of the network switch; and
responsive to determining that the actual connection does not match the expected connection, transmitting, by the processor, an alert.

14. The method of claim 13, wherein determining the expected connection comprises accessing a cable map describing correct connections between the computing node and the network switch.

15. The method of claim 13, wherein determining the actual connection comprises accessing an ARP table stored in the network switch.

16. The method of claim 15, wherein the ARP table comprises a port number of the first port of the network switch, an IP address of the first port of the computing node connected to the first port of the network switch, and a MAC address of the first port of the computing node connected to the first port of the network switch.

17. The method of claim 13, wherein the alert comprises a physical location of the network switch.

18. The method of claim 13, wherein the processor is included in one of a management server or a serial concentrator.

19. The method of claim 13, further comprising:
selecting, by the processor, a second port of the computing node to cross check;
determining, by the processor, an expected connection between the second port of the computing node and a second port of a second network switch;
determining, by the processor, an actual connection of the second port of the second network switch;
determining, by the processor, whether the actual connection of the second port of the second network switch matches the expected connection between the second port of the computing node and the second port of the second network switch; and
responsive to determining that the actual connection does not match the expected connection, transmitting, by the processor, an alert.

20. The method of claim 19, wherein the network switch and the second network switch are redundant network switches coupling the processor and the computing node.
